(19) United States
(12) Patent Application Publication
(10) Pub. No.: US 2011/0192389 A1
(43) Pub. Date: Aug. 11, 2011

(54) ENVIRONMENTALLY-FRIENDLY CUTTING APPARATUS USING A WIRE SAW, AND CUTTING METHOD USING SAME

(76) Inventor: Eun Young Jang, Seoul (KR)

(21) Appl. No.: 13/123,486

(22) PCT Filed: Oct. 7, 2009
(86) PCT No.: PCT/KR2009/005712

§ 371 Date: Apr. 8, 2011

(30) Foreign Application Priority Data
Oct. 8, 2008 (KR) 10-2008-0098624

(51) Int. Cl. B28D 1/08

(52) U.S. Cl. 125/21

(57) ABSTRACT

The present invention relates to an apparatus and to a method for cutting a concrete structure using a diamond wire saw. More particularly, the present invention relates to an environmentally-friendly cutting apparatus using a wire saw and to a cutting method using the same, capable of completely collecting concrete sludge and dust generated during the cutting of the concrete structure without deteriorating work efficiency, and specially controlling the sludge generated during underwater cutting in an efficient manner to prevent environmental contamination. The cutting apparatus of the present invention comprises a jig case and a sealing cover unit for sealing the cut surface of a target structure for cutting, a wire saw, and a jig for changing the direction (a set of pulleys for guiding the wire saw), thus perfectly preventing dust and sludge generated during cutting of the structure from being exposed to the air or water to prevent environmental contamination. Further, the present invention is advantageous as it prevents the wire saw and the jig for changing direction from being outwardly exposed, which may otherwise cause injury to workers during cutting, thus improving the safety of cutting work. Further, the present invention collects sludge generated during the cutting of the structure, enables the collected sludge to settle in a settling tank, and enables purified upper water to be supplied to the sealing cover unit from a water purifying channel and be reused as a coolant for cooling the frictional heat on the cut surface, thus preventing environmental contamination and saving resources.

### TECHNICAL FIELD

The present invention relates to an apparatus and a method for cutting a concrete structure by using a diamond wire saw, and in particular to an environment-friendly wire saw cutting apparatus and a cutting method using the same which both make it possible efficiently collect concrete sludge and dusts produced during works without deteriorating a work efficiency during a cutting work of a concrete structure, efficiently control the sludge produced during an underwater work, thus preventing environmental contamination.

### BACKGROUND ART

As a dismantling method of concrete structures, a diamond wire saw method is widely used in industrial field.

The diamond wire saw method is basically directed to connecting a diamond wire saw to a structure to be cut, and a driving pulley is transferred with the aid of a hydraulic cylinder while both rotating a pulley (driving pulley) at a high speed and providing a tensional force to a wire, thus cutting the structure.

The conventional diamond wire saw method does not have any limits in a cutting depth and a cutting angle of a structure, and a precise cutting work is possible without providing any damages to an existing structure, and a cutting work can be performed irrespective of the dimension of a structure to be cut.

In the above-described conventional diamond wire saw cutting method, the heat generated by means of frictions at a cutting portion in the course of cutting work is cooled by water injection.

In case of the above wet type cutting, cutting efficiency is good, but about 600 liter per hour of sludge mixed with dusts of water, concrete and cutting material of above is sprayed in the air or discarded at a work site, and in case of underwater cutting work, such sludge might be discharged into the sea or river, which contaminates the sea, river or other areas.

In order to overcome the above problems, a dry type wire saw cutting method is under development, which can perform cutting works without injecting water in the course of ground work, but cooling efficiency is bad, which leads to low work efficiency, so such method is not currently considered as being efficient.

The dry type wire saw method cannot be used for an underwater construction. In case of areas with a lot of sea sides, river or stream, an environment-friendly cutting device and a cutting method are urgently needed in the industry, which can be used with excellent work efficiency for both underwater concrete cutting work and ground work.

### DISCLOSURE OF THE INVENTION

Accordingly, it is an object of the present invention to provide a new concept which overcomes the problems encountered in the conventional art and recycles spent sludge via precipitation-purification procedures.

It is another object of the present invention to provide an environment-friendly wire saw cutting apparatus and a cutting method using the same in which a cutting surface of a structure to be cut, a wire saw and a jig for a direction change are encased with a jig casing and a sealing cover part for thereby preventing the dusts and sludge produced in the course of cutting work of a structure from being exposed into the air or underwater, which consequently prevents environment contamination. Work safety can be enhanced by preventing a wire saw and a direction change jig from being exposed to the outside, the exposure of which can hurt worker in the course of cutting work.

It is further another object of the present invention to provide an environment friendly wire saw cutting device and a cutting method using the same which both make it possible to prevent environment damages and save resources in such a manner that the sludge produced in the course of cutting structures is collected and precipitated in a precipitation tank, and the precipitated upper water is purified in a purification tank and again is supplied to a sealing cover part for the use of coolant which cools heat at a cutting surface.

To achieve the above objects, there is provided an environment friendly wire saw cutting device formed of a diamond wire saw which rotates, at a high speed, surrounding a portion of a structure to be cut, and a driving part which drives the wire saw which comprises a direction change jig which is positioned at one side of the structure to be cut and includes a plurality of pulleys for guiding a traveling direction of the wire saw operating with the driving part; a jig casing which is fixed at the structure for the direction change jig to be accommodated in the sealed inner space; a sealing cover part the both ends of which are connected with an inner space of the jig casing, respectively, the sealing cover part being closely fixed covering the cutting portions along the surface of the structure around which the wire saw is wound, the sealing cover part being formed in a tube shape with its inner side being open; a sludge discharge part which includes a hydraulic device connected with a lower side of the jig casing for discharging sludge and dusts produced when the structure is cut off, a precipitation tank for collecting the sludge and dusts, and a discharge tube connecting the jig casing and the precipitation tank; a water purification tank for purifying the upper water residing at the upper side as the sludge from the precipitation tank is precipitated; and a water supply tube for supplying the water of the water purification tank into the interior of the sealing cover part, with one end being connected with the water purification tank, with the other end being connected with an upper side of the sealing cover part.

To achieve the above objects, there is provided an environment friendly wire saw cutting device formed of a diamond wire saw for cutting at a high speed in a state that a wire saw is inserted into a through hole formed at a corner portion of an inner through cut portion of a structure, and a driving part for driving the wire saw, which comprises a direction change jig which is provided at one side of the through cut portion and includes a plurality of pulleys for guiding a traveling direction of the wire saw operating with the driving part; a jig casing which is closely fixed at the structure for the direction change jig to be accommodated in its sealed inner space for thereby covering the front side of the through cut portion to be formed; a sealing cover part which is closely fixed at the structure for covering the back side of the through cut portion to be formed; and a sludge discharge part which includes a hydraulic device connected with a lower side of the jig casing for discharging the sludge and dusts produced while the structure is being cut off, a precipitation tank for collecting the sludge and dusts, and a discharge tube connecting the jig casing and the precipitation tank.

In addition, there are further provided a water purification tank which purifies the upper water positioned at the upper side as the sludge collected from the interior of the precipitation tank precipitates; and a water supply tube for supplying the water of the water purification tank into the interior of the sealing cover part, with one end being connected with the water purification tank, with the other end being connected with an upper side of the sealing cover part.

The sealing cover part comprises a wing part which is horizontally formed at both open sides, with its cross section being formed in a channel shape; and an engaging member which engages the wing part at the surface of the structure in a through engagement way.

The both ends of the sealing cover part are closely engaged with the surface of the structure in such a manner that an epoxy resin is coated and hardened at an engaging portion and gaps.

The sludge discharge part is formed in a structure that a cylinder pump is connected with a lower side of the jig casing, and a discharge tube is connected with its lower end, and the sludge produced in the jig casing and the interior of the sealing cover part with the aid of a reciprocating operation of the piston by a hydraulic motor is discharged into the precipitation tank, and the hydraulic device, which is a driving source of the hydraulic motor, is connected with the hydraulic driving force line.

A check valve is disposed between the cylinder pumps connected with the jig casing for thereby adjusting the discharge amount of the sludge.

There is further provided a temporal jig which is positioned on the same straight line as the direction change jig positioned underwater on the surface of the structure wherein when the structure to be cut is positioned underwater, the driving part and the precipitation tank are positioned on the surface of water, whereby the traveling direction of the wire saw cooperating with the driving part is changed to a vertical lower portion in which the direction change jig is positioned.

In addition, there is further provided a vertical cover part which is disposed between the direction change jig and the temporal jig and has a certain height, with its lower end being connected to an inner space of the jig casing in a tube shape the upper and lower sides of which are being open, with the wire saw being inserted into the same.

The pulleys of the direction change jig each have a pair of guide shoulders in its surrounding direction, which are either extended or further attached in order to prevent the wire saw from being derailed, the wire saw being wound at an inner side.

To achieve the above objects, there is provided a cutting method using an environment friendly wire saw cutting device formed of a diamond wire saw cutting a cutting portion of a structure in a surrounding state, and a driving part for driving the wire saw, which comprises (1) a step in which a sealing cover part and a jig casing are installed, which seal a wire saw and a direction change jig installed at a cutting portion of the structure; (2) a step in which the sludge and dust produced while the wire saw rotates at a high speed and cuts the structure are collected in the sealing cover part and the interior of the jig casing; (3) a step in which the collected sludge and dusts are discharged into a precipitation tank with the aid of a hydraulic device; (4) a step in which when the sludge in the interior of the precipitation tank precipitates, the upper water residing at the upper side is filtered and discharged to a water purification tank; and [5] a step in which the upper water of the water purification tank is supplied to the inner side of the sealing cover part via a water supply tube, thus cooling the heat occurring at the cutting potions of the structure.

The step (1) comprises a sub-step in which an epoxy resin is coated at an engaging portion and gaps, and is hardened and sealingly fixed, so that the both ends of the sealing cover part closely contact with the surface of the structure.

There is provided a cutting method by using a wire saw cutting device which includes a diamond wire saw designed to cut by punching a corner or a portion to be through-cut at an inner side of a structure is inserted into a punched through hole, and a driving part for driving the same, which method comprises (1) a step for punching a corner of a portion to be through-cut at an inner side of a structure and forming a through hole, (2) a step for inserting in sequence the wire saw into a pair of neighboring through holes among a plurality of through holes punched at the corner, (3) a step for installing a sealing cover part and a jig casing for sealing the front and rear direction change jigs of the through cut portions at the inner side of the structure, (4) a step for cutting the structure by using the wire saw rotating at a high speed and collecting the sludge and dust into the sealing cover part and the jig casing, (5) a step for discharging the collected sludge and dust into a precipitation tank via a hydraulic device, (6) a step for filtering and the upper water positioned at an upper side when the sludge precipitates in the interior of the precipitation tank and discharging into a purification tank, and (7) a step for supplying the upper water of the purification tank into the inner side of the sealing cover part via a water supply pipe for thereby cooling the heat at the cutting surface of the structure.

### ADVANTAGEOUS EFFECTS

The present invention has advantageous effects of preventing environment contaminations in such a manner that a jig casing and a sealing cover part are provided for encasing a cutting surface of a structure to be cut and a wire saw and a direction change jig, thus basically preventing dust and sludge produced in the course of structure cutting into the air or underwater.

The work safety can be significantly enhanced by preventing a wire saw and a direction change jig from being exposed to the outside, the exposure of which might hurt workers in the course of cutting work.

The sludge produced in the course of structure cutting is collected and precipitated in a precipitation tank, and the purified upper water is supplied from a purification tank to a sealing cover part for the use as cooling water for cooling friction heat at a cutting surface, thus preventing environmental damages and saving resources.

### BRIEF DESCRIPTION OF THE DRAWINGS

The present invention will become better understood with reference to the accompanying drawings which are given only by way of illustration and thus are not limitative of the present invention, wherein;

FIGS. 1 and 2 are views illustrating a schematic structure of a wire saw cutting device according to the present invention;

FIG. 3 is a view illustrating a structure to be cut and a wire saw cutting direction according to the present invention;

FIG. 4 is a view illustrating the internal constructions of a direction change jig and a jig casing according to the present invention;

FIG. 5 is a view illustrating the configuration of a sealing cover part according to the present invention; and

FIGS. 6 and 7 are views illustrating the states that the inner sides of a structure to be cut are through-cut by using a wire saw cutting device according to the present invention.

<Descriptions of major elements of the drawings>

| | | | |
|---|---|---|---|
| 1. | Structure | 10: | wire saw |
| 20: | driving part | 30: | direction change jig |
| 100: | jig casing | 200: | sealing cover part |
| 300: | sludge discharge part | 310: | cylinder pump |
| 320: | hydraulic pump | 330: | hydraulic driving force line |
| 340: | hydraulic device | 350: | precipitation tank |
| 400: | purification tank | 410: | water supply pipe |
| 500: | vertical cover part | | |

### MODES FOR CARRYING OUT THE INVENTION

The present invention will be described with reference to the accompanying drawings. In the descriptions, what the descriptions on the related known functions or constructions the subject matters of the present invention unclear will be omitted.

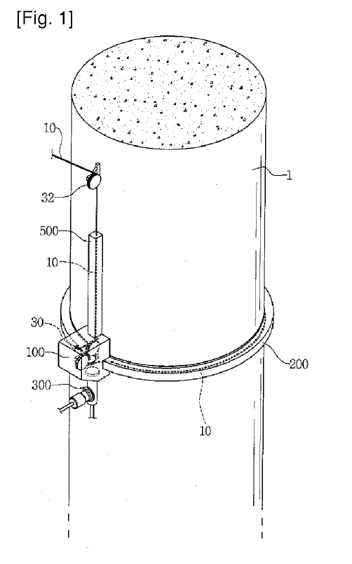

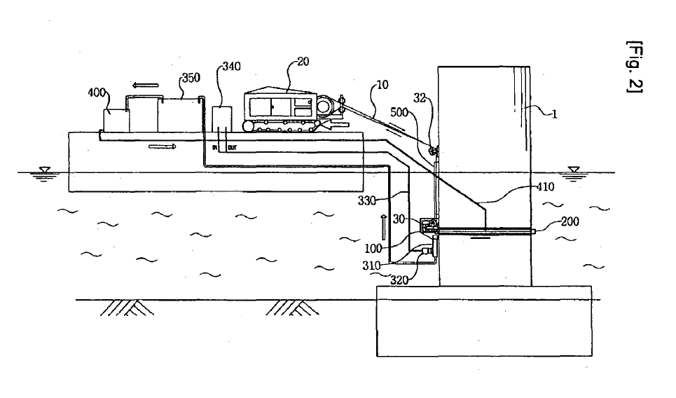

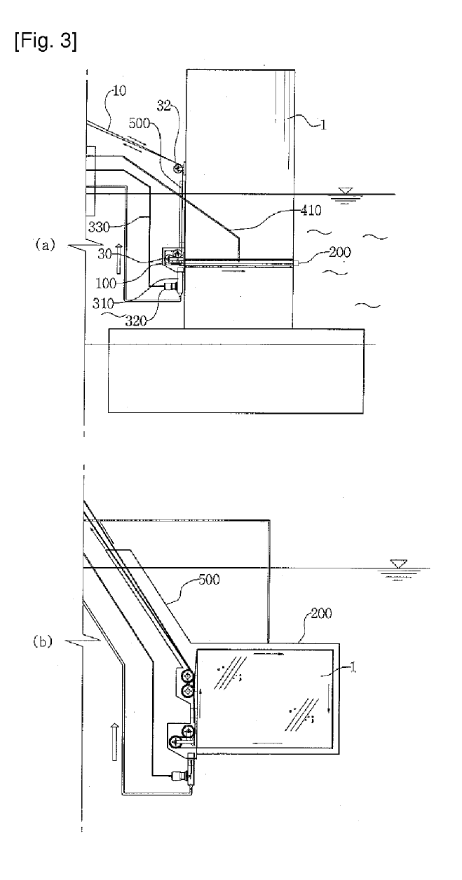

FIGS. 1 and 2 are views illustrating a schematic structure of a wire saw cutting device according to the present invention, and FIG. 3 is a view illustrating a structure to be cut and a wire saw cutting direction according to the present invention.

As shown in FIGS. 1, 2 and 3, the environment friendly wire saw device according to the present invention comprises a wire saw 10, a driving part 20, a direction change jig 30, a jig casing 100, a sealing cover part 200, a sludge discharge part 300, a water purification part 300, a water purification tank 400 and a temporal jig 32.

The wire saw 10 is configured with its one side being connected with a driving part 20, with its other side surrounding a portion of a structure to be cut in a band shape.

The wire saw 10 is configured to prevent its direction change and derail with the aid of the direction change jig 30 and the temporal jig 32.

The direction change jig 30 is formed of at least one pulley 32 for guiding the traveling direction of the wire saw 10 and is encased so that the wire saw 10 provides a certain tensional force to the cutting portion of the structure 1 while rotating at a high speed.

As shown in FIG. 3A, the structure 1 to be cut is installed upright, and the cutting surface of the structure 1 remains horizontal with respect to the ground, and the wire saw 10 surrounds the structure 1 in a horizontal direction, thus cutting the structure.

As shown in FIG. 3B, the structure 1 keeps horizontal with respect to the ground, and the cutting surface of the structure 1 remains vertical with respect to the ground, and the wire saw 10 vertically surrounds the structure 1, thus cutting the structure 1.

The pulley 32 of the direction change jig 30 each comprises a pair of guide shoulders 32a along each surrounding portion. Here, the guide shoulder 32a is extended to be opposite with each other in pairs along the outer surrounding portion of the pulley 32 or is further attached, thus preventing the derail of the wire saw 10 being surrounded at the inner side of the pulley 32.

When there is a difference between the cutting portion of the structure 1 and the height of the driving part 20, for example, when the cutting portion is located at a lower underwater portion, and the driving part is located on the surface of water, the driving part 20, the hydraulic device 340, the precipitation tank 350 and the water purification tank 400 are positioned on the surface of water. At this time, the traveling direction of the wire saw 10 can change by means of the temporal jig 32 fixedly provided above a certain height from a straight line of the direction change jig 30.

The wire saw 10 is drivingly connected with the temporal jig 32 and the direction change jig 30. Since the driving part 20 moves backwards while the driving part 20 rotates at a high speed, the structure 1 is cut by means of the wire saw 10.

The jig casing 100, the sealing cover part 200 and the vertical cover part 500 all are fixed on the surface of a certain portion of the structure 1 while covering the wire saw 10 and the direction change jig 30.

The jig casing 100 encases the direction change jig 30 in its closed inner space, so it is possible to preferably prevent the sludge producing in the course of cutting the structure 1 from being discharged toward the lower side.

The sealing cover part 200 has a certain length corresponding to the surface of the structure 1 so as to substantially cover the wire saw 10 surrounding the structure 1 and the cutting portion and is formed with its inner side being open when seeing from its cross section and is closely fixed at the surface of the structure 1.

At this time, the inner side of the sealing cover part 200 covering the wire saw 10 and the cut-away portion of the structure 1 and the inner space of the jig casing 100 keep communicating with each other in a sealed state, and the both ends of the sealing cover part 200 are engaged with the sides of the jig casing 100.

The vertical cover part 500 is formed in a tube shape with its upper and lower end portions being open, having a hollow space and is positioned between the direction change jig 30 and the temporal jig 32.

The inner through space of the vertical cover part 500 and the inner space of the jig casing 100 remain communicating with each other, and the wire saw 10 is inserted, and the lower side of the vertical cover part 500 is engaged with the upper side of the jig casing 100.

At this moment, the temporal jig 32 is fixed at the surface of the structure 1 and it is preferred that the temporal jig 32 is exposed above the water surface. When the temporal jig 32 is positioned underwater, it is provided at an inner side to be surrounded by the vertical cover part 500.

There is provided a sludge discharge part 300 connected to a lower side of the jig casing 100 for thereby discharging the sludge and dusts collected by means of the jig casing 100 and the sealing cover part 200.

The sludge discharge part 300 discharges the sludge and dusts to the precipitation tank 350 via the discharge tube with the aid of the hydraulic device 340.

The sludge from the interior of the precipitation tank 350 is precipitated in the water purification tank 400, and the upper water residing on the highest portion is filtered and transferred to the water purification tank 400.

The upper water of the water purification tank 400 is supplied to the interior of the sealing cover part 200 via the water supply tube 410 with the aid of the water supply pump or natural pressure.

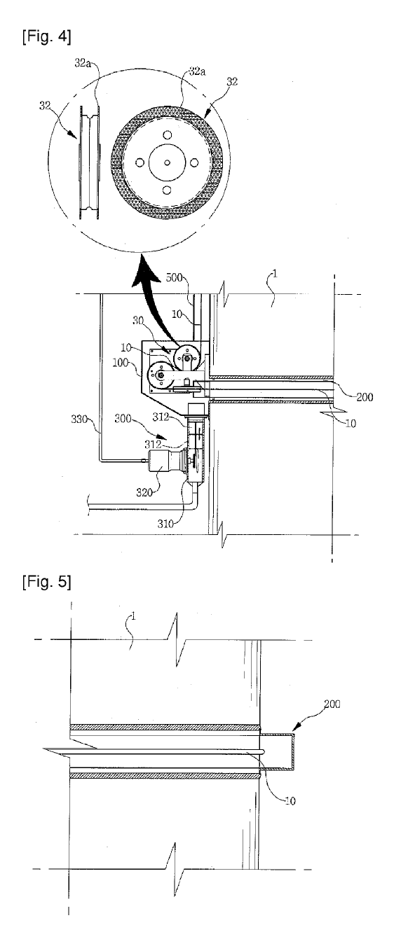

FIG. 4 is a view illustrating the inner constructions of the direction change jig and the jig casing according to the present invention.

As shown in FIG. 4, the sludge discharge part 300 comprises a cylinder pump 310, a hydraulic motor 320, a hydraulic driving force line 330, a hydraulic device 340 and a precipitation tank 350.

The cylinder pump 310 is connected to a lower side of the jig casing 100 tapered downwards, and comprises a discharge tube connecting the lower side of the cylinder pump 310 and the precipitation tank 350.

The piston 312 of the interior of the cylinder pump 310 reciprocates upwards and downwards with the aid of the hydraulic motor 320 drivingly connected with the hydraulic device 340, which is a driving force source), via the hydraulic driving force line 330, according to which the sludge of the jig casing 100 and the sealing cover part 200 is discharged to the precipitation tank 350.

In order to adjust the discharging amount of the sludge, there is a check valve is disposed between the jig casing 100 and the cylinder pump 310.

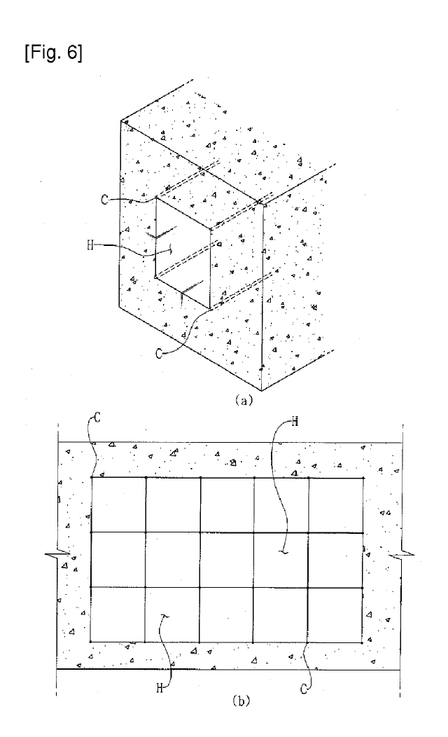

FIG. 5 is a view illustrating a sealing cover part according to the present invention.

As shown in FIG. 5, the sealing cover pat 200 is formed of a cross section of a channel shape or a semi-circular shape with its inner side being open in a longitudinal tube shape, with a wing part being provided at both open ends and having a certain area.

The wing part of the sealing cover part 200 is through-engaged with the aid of an engaging member (not shown), while closely contacting with the surface of the structure 1. At this time, the engaging member might be a bolt, screw, anchor, etc.

It is preferred that the wing part of the sealing cover part 200 is made while being closely contacted with the surface of the structure 1 with the aid of an engaging member made of an epoxy resin material, the epoxy resin being coated and hardened at the gaps of the engaging part, thus enhancing a water proof performance and an anti-vibration performance.

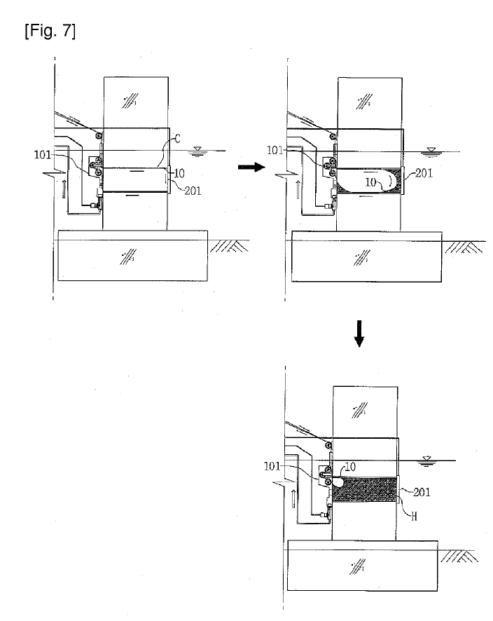

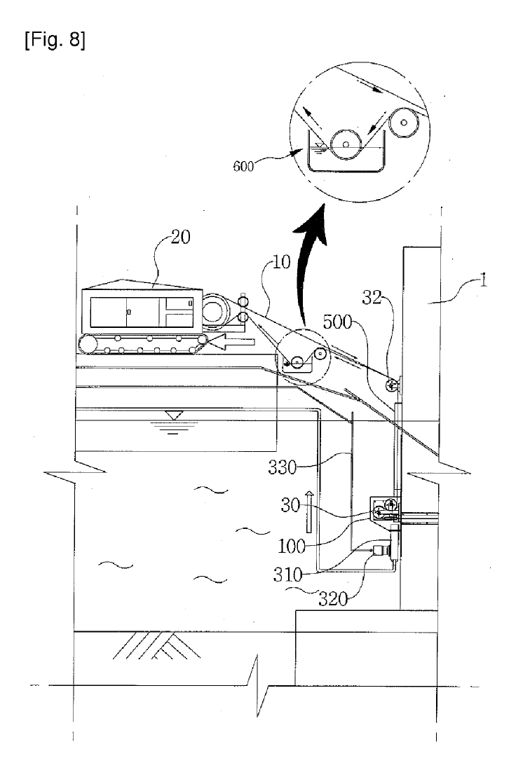

FIGS. 6 and 7 are views illustrating the states that the inner sides of a structure to be cut are through-cut by using a wire saw cutting device according to the present invention.

According to another embodiment of the present invention, FIGS. 6 and 7 show a wire saw for forming a through cut portion H passing through in a certain shape the interior of the structure 1 to be cut.

According to an embodiment of the present invention, the environment friendly wire saw cutting device comprises a wire saw 10, a driving part 20, a direction change jig 30, a jig casing 101, a sealing cover part 201, a sludge discharge part 300, a water purification tank 400, and a temporal jig 32.

The direction change jig 30 is positioned at a portion of the through cut portion H, and the wire saw 10 connected to the driving part 20 passes through a through hole C.

According to an embodiment of the present invention, a through hole C is formed by using a core drill or something at the corner portions corresponding to the corners at a cross section of the through cut portion H in order to form the through cut portion H passing through in a rectangular frame shape at the inner side of the structure 1.

The through hole C has a certain diameter enough to receive the wire saw 10.

As shown in FIG. 6A, among four through holes C corresponding to the corner portions of the through cut portion passing through in a rectangular frame shape, the wire saw 10 is inserted into the through hole C of the upper left side and is connected to the direction change jig 30 to pass through the through hole C of the upper right side, and the high speed rotation by means of the driving part 20 helps cut the upper side of the through cut portion H.

The wire saw 10 is inserted into the through hole C of the lower left side and passes through the through hole C of the lower right side for thereby cutting the lower side of the through cut portion H.

In the same manner, the wire saw 10 is inserted into the through hole C of the upper left side and passes through the through hole C of the lower left side and is connected with the direction change jig 30, and the high speed rotation by the driving part 20 helps cut the left side of the through cut portion H, and the wire saw 10 is inserted into the through hole C of the upper right side and passes through the through hole C of the lower right side for thereby cutting the right side of the through cut portion H.

So, the through cut portion H is formed at the inner side of the structure 1. Since the through cut portion H is too large to cut one time, as shown in FIG. 6B, the through cut portion H might be divided into multiple portions by forming multiple through holes C for thereby preferably cutting multiple times.

The sealing cover part 201 and the jig casing 101 are fixed at the surface of the structure 1 so as to sealingly cover the direction change jig 30 and the through cut portion H.

Here, the jig casing 101 encases the direction change jig 30 in its inner space and is closely fixed at the structure 1 so as to sealingly cover the front side of the through cut portion H. In addition, the sealing cover part 201 is closely fixed at the structure 1 so as to sealingly cover the back side of the through cut portion H.

The sealing cover part 201 might be formed in a structure of covering only the wire saw 10 positioned at the portions corresponding to the upper and lower sides and left and right sides of the through cut portion H or might be formed in a structure of covering the entire portions of the through cut portion H including the wire saw 10 positioned at the portions corresponding to the upper and lower sides and the left and right sides of the through cut portion H.

When the wire saw 10 rotates while being attached, on its surface, with the dusts or sludge produced in the course of cutting the structure 1, the sludge attacked at the wire saw 10 between the driving part 20 and the direction change jig 30 might spread, in order to prevent which there is preferably provided a wire washing part 600.

Water or washing liquid is filled in the wire washing part 600 at a certain height, and the wire saw 10 is forced to pass through the water or washing liquid in submerged state, thus washing and cleaning the dusts and sludge attached on the surface of the wire saw 10.

The wire washing part 600 includes a discharge tube (not shown) connected to the precipitation tank 350, by which the sludge collected from the wire saw 10 can be discharged to the precipitation tank 350.

It is preferred that the wire washing part 600 is provided at a portion before the introduction into the inner side of the driving part 20 past the cutting portion of the structure 1.

The cutting method using the environment friendly wire saw cutting device with the above construction according to the present invention will be described.

During the cutting work of the structure to be cut according to the present invention, sludge and dusts are collected at the sealing cover part 200 covering the cutting portions of the structure 1, the sealing cover part 200 covering the wire saw 10, and the direction change jig 30, and the collected sludge and dusts are discharged into the precipitation tank 350 via the hydraulic device 340, and the sludge and dusts are collected at the inner side of the jig casing 100 covering the direction change jig casing 30.

The sludge is precipitated in the interior of the precipitation tank 350, and only the upper water positioning at the upper side is filtered and transferred to the water purification tank 400.

The upper water purified by the water purification tank 400 is supplied to the inner side of the sealing cover part 200 via the water supply tube 410, and the upper water functions as cooling water.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. An environment friendly wire saw cutting device formed of a diamond wire saw which rotates, at a high speed, surrounding a portion of a structure to be cut, and a driving part which drives the wire saw, comprising:
a direction change jig which is positioned at one side of the structure to be cut and includes a plurality of pulleys for guiding a traveling direction of the wire saw operating with the driving part;
a jig casing which is fixed at the structure for the direction change jig to be accommodated in the sealed inner space;
a sealing cover part the both ends of which are connected with an inner space of the jig casing, respectively, said sealing cover part being closely fixed covering the cutting portions along the surface of the structure around which the wire saw is wound, said sealing cover part being formed in a tube shape with its inner side being open;
a sludge discharge part which includes a hydraulic device connected with a lower side of the jig casing for discharging sludge and dusts produced when the structure is cut off, a precipitation tank for collecting the sludge and dusts, and a discharge tube connecting the jig casing and the precipitation tank;
a water purification tank for purifying the upper water residing at the upper side as the sludge from the precipitation tank is precipitated; and
a water supply tube for supplying the water of the water purification tank into the interior of the sealing cover part, with one end being connected with the water purification tank, with the other end being connected with an upper side of the sealing cover part.

2. An environment friendly wire saw cutting device formed of a diamond wire saw for cutting at a high speed in a state that a wire saw is inserted into a through hole formed at a corner portion of an inner through cut portion of a structure, and a driving part for driving the wire saw, comprising:
a direction change jig which is provided at one side of the through cut portion and includes a plurality of pulleys for guiding a traveling direction of the wire saw operating with the driving part;
a jig casing which is closely fixed at the structure for the direction change jig to be accommodated in its sealed inner space for thereby covering the front side of the through cut portion to be formed;
a sealing cover part which is closely fixed at the structure for covering the back side of the through cut portion to be formed;
a sludge discharge part which includes a hydraulic device connected with a lower side of the jig casing for discharging the sludge and dusts produced while the structure is being cut off, a precipitation tank for collecting the sludge and dusts, and a discharge tube connecting the jig casing and the precipitation tank;
a water purification tank which purifies the upper water positioned at the upper side as the sludge collected from the interior of the precipitation tank precipitates; and
a water supply tube for supplying the water of the water purification tank into the interior of the sealing cover part, with one end being connected with the water purification tank, with the other end being connected with an upper side of the sealing cover part.

3. An environment friendly wire saw cutting device according to claim 1, wherein said sealing cover part comprises:
a wing part which is horizontally formed at both open sides, with its cross section being formed in a channel shape; and
an engaging member which engages the wing part at the surface of the structure in a through engagement way.

4. An environment friendly wire saw cutting device according to claim 1, wherein the both ends of said sealing cover part are closely engaged with the surface of the structure in such a manner that an epoxy resin is coated and hardened at an engaging portion and gaps.

5. An environment friendly wire saw cutting device according to claim 1, wherein said sludge discharge part is formed in a structure that a cylinder pump is connected with a lower side of the jig casing, and a discharge tube is connected with its lower end, and the sludge produced in the jig casing and the interior of the sealing cover part with the aid of a reciprocating operation of the piston by a hydraulic motor is discharged into the precipitation tank, and the hydraulic device, which is a driving source of the hydraulic motor, is connected with the hydraulic driving force line.

6. An environment friendly wire saw cutting device according to claim 5, wherein a check valve is disposed between the cylinder pumps connected with the jig casing for thereby adjusting the discharge amount of the sludge.

7. An environment friendly wire saw cutting device according to claim 1, further comprising a temporal jig which is positioned on the same straight line as the direction change jig positioned underwater on the surface of the structure wherein when the structure to be cut is positioned underwater, the driving part and the precipitation tank are positioned on the surface of water, whereby the traveling direction of the wire saw cooperating with the driving part is changed to a vertical lower portion in which the direction change jig is positioned.

8. An environment friendly wire saw cutting device according to claim 7, further comprising a vertical cover part which is disposed between the direction change jig and the temporal jig and has a certain height, with its lower end being connected to an inner space of the jig casing in a tube shape the upper and lower sides of which are being open, with said wire saw being inserted into the same.

9. An environment friendly wire saw cutting device according to claim 1, wherein the pulleys of said direction change jig each have a pair of guide shoulders in its surrounding direction, which are either extended or further attached in order to prevent the wire saw from being derailed, the wire saw being wound at an inner side.

10. A cutting method using an environment friendly wire saw cutting device formed of a diamond wire saw cutting a cutting portion of a structure in a surrounding state, and a driving part for driving the wire saw, comprising:
(1) a step in which a sealing cover part and a jig casing are installed, which seal a wire saw and a direction change jig installed at a cutting portion of the structure;
(2) a step in which the sludge and dust produced while the wire saw rotates at a high speed and cuts the structure are collected in the sealing cover part and the interior of the jig casing;
(3) a step in which the collected sludge and dusts are discharged into a precipitation tank with the aid of a hydraulic device;
(4) a step in which when the sludge in the interior of the precipitation tank precipitates, the upper water residing at the upper side is filtered and discharged to a water purification tank; and
[5] a step in which the upper water of the water purification tank is supplied to the inner side of the sealing cover part via a water supply tube, thus cooling the heat occurring at the cutting potions of the structure,
wherein said step (1) comprises a sub-step in which an epoxy resin is coated at an engaging portion and gaps, and is hardened and sealingly fixed, so that the both ends of the sealing cover part closely contact with the surface of the structure.

11. An environment friendly wire saw cutting device according to claim 2, wherein said sludge discharge part is formed in a structure that a cylinder pump is connected with a lower side of the jig casing, and a discharge tube is connected with its lower end, and the sludge produced in the jig casing and the interior of the sealing cover part with the aid of a reciprocating operation of the piston by a hydraulic motor is discharged into the precipitation tank, and the hydraulic device, which is a driving source of the hydraulic motor, is connected with the hydraulic driving force line.

12. An environment friendly wire saw cutting device according to claim 11, wherein a check valve is disposed between the cylinder pumps connected with the jig casing for thereby adjusting the discharge amount of the sludge.

13. An environment friendly wire saw cutting device according to claim 2, further comprising a temporal jig which is positioned on the same straight line as the direction change jig positioned underwater on the surface of the structure wherein when the structure to be cut is positioned underwater, the driving part and the precipitation tank are positioned on the surface of water, whereby the traveling direction of the wire saw cooperating with the driving part is changed to a vertical lower portion in which the direction change jig is positioned.

14. An environment friendly wire saw cutting device according to claim 13, further comprising a vertical cover part which is disposed between the direction change jig and the temporal jig and has a certain height, with its lower end being connected to an inner space of the jig casing in a tube shape the upper and lower sides of which are being open, with said wire saw being inserted into the same.

15. An environment friendly wire saw cutting device according to claim 2, wherein the pulleys of said direction change jig each have a pair of guide shoulders in its surrounding direction, which are either extended or further attached in order to prevent the wire saw from being derailed, the wire saw being wound at an inner side.
